(19) United States
(12) Patent Application Publication
(10) Pub. No.: US 2009/0235365 A1
(43) Pub. Date: Sep. 17, 2009

(54) DATA ACCESS SYSTEM

(76) Inventors: Tung-Cheng Kuo, Hsin-Chu City (TW); Ching-Sung Yang, Hsinchu City (TW); Ruei-Ling Lin, Hsinchu County (TW); Cheng-Jye Liu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/258,430

(22) Filed: Oct. 26, 2008

Related U.S. Application Data
(60) Provisional application No. 61/036,084, filed on Mar. 13, 2008.

(51) Int. Cl. H04L 9/32; G06F 17/30

(52) U.S. Cl. 726/29

(57) ABSTRACT

A data access system includes a host and a storage device. The host has a security setup function and includes a first identity code storage block to store a first identity code. The storage device has a security check function and includes a second identity code storage block. The host executes the security setup function to set a second identity code according to the first identity code, and the second identity code is stored into the second identity code storage block. The storage device executes the security check function to determine if the host is allowed to access the storage device according to the first and second identity codes.

### CROSS REFERENCE TO RELATED APPLICATIONS

This application claims the priority of U.S. Provisional Application No. 61/036,084, filed Mar. 13, 2008, which is included herein by reference.

### BACKGROUND OF THE INVENTION

1. Field of the Invention

The present invention relates to a data access system, and more particularly, to a data access system having a security setup function and a security check function.

2. Description of the Prior Art

Portable storage devices such as MMC/CF memory cards or flash memory store data that can be rapidly and conveniently accessed by a number of hosts. Because these portable storage devices do not have security check functions, however, there is no restriction on which hosts the portable storage devices can be accessed by. If the portable storage device contains confidential or private data, this data may be leaked due to the lack of this security check function if the portable storage device is lost or misplaced.

### SUMMARY OF THE INVENTION

It is therefore an objective of the present invention to provide a data access system having a security setup function and security check function, to ensure that the portable storage device can only be accessed by a specific host, therefore avoiding theft of confidential or private data stored in the portable storage device.

According to one embodiment of the present invention, a data access system includes a host and a storage device. The host has a security setup function and includes a first identity code storage block to store a first identity code. The storage device has a security check function and includes a second identity code storage block. The host executes the security setup function to set a second identity code according to the first identity code, and the second identity code is stored into the second identity code storage block. The storage device executes the security check function to determine if the host is allowed to access the storage device according to the first and second identity codes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data access system according to one embodiment of the present invention.

FIG. 2 is a flowchart of operations of the data access system shown in FIG. 1.

### DETAILED DESCRIPTION

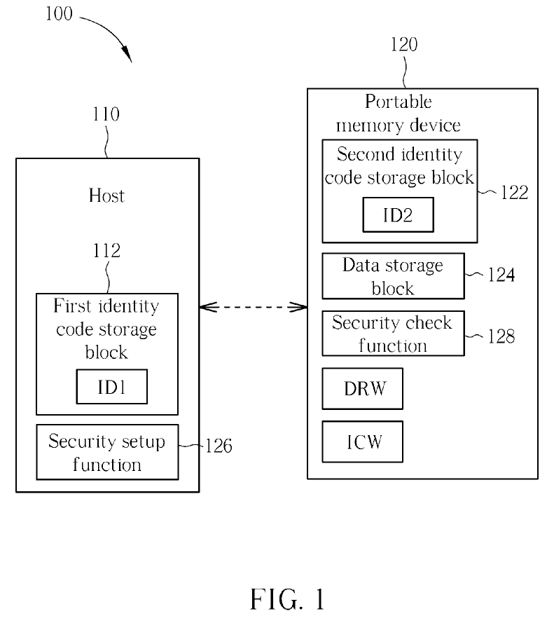

Please refer to FIG. 1. FIG. 1 is a diagram illustrating a data access system 100 according to one embodiment of the present invention. As shown in FIG. 1, the data access system 100 includes a host 110 and a storage device (in this embodiment, a portable memory device 120 serves as the storage device). The host 110 includes a security setup function 126 and a first identity code storage block 112, where a first identity code ID1 is stored in the first identity code storage block 112. The portable memory device 120 includes a second identity code storage block 122 that is used for storing a second identity code ID2, a data storage block 124, a security check function 128, a data read/write_enable control code DRW, and an identity code write-disable control code ICW. In this embodiment, the data read/write_enable control code DRW and the identity code write-disable control code ICW are, respectively, a control bit. The host 110 can be a computer, notebook or cell phone, and the portable memory device 120 can be a memory card or flash memory.

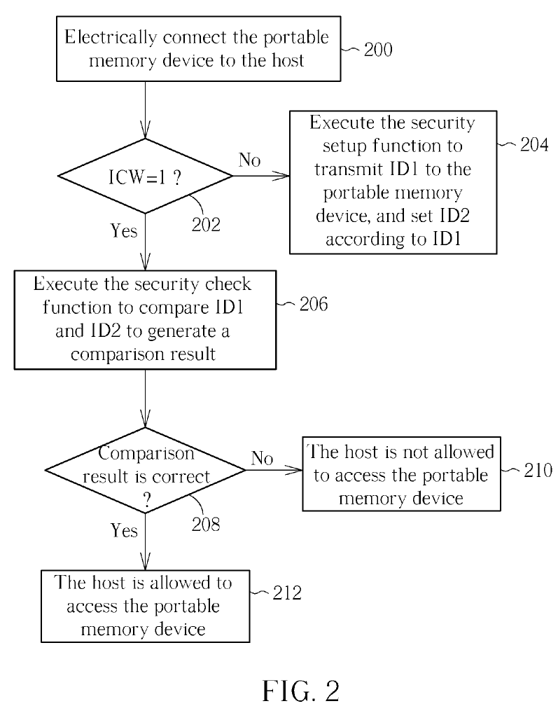

Please refer to FIG. 1 and FIG. 2 together. FIG. 2 is a flowchart of operations of the data access system 100 shown in FIG. 1. It is noted that, provided the result is substantially the same, the steps are not limited to be executed according to the exact order shown in FIG. 2. Referring to the flowchart shown in FIG. 2, the operations of the data access system 100 are described as follows:

In Step 200, the portable memory device 120 is electrically connected to the host 110. Then, in Step 202, the host 110 checks the identity code write-disable control code ICW in the portable memory device 120. If the identity code write-disable control code ICW has a status “0”, this represents that the second identity code storage block 122 of the portable memory device 120 does not have the second identity code ID2. In this case, the flows enters Step 204 to execute the security setup function 126; if the identity code write-disable control code ICW has a status “1”, this represents that the second identity code storage block 122 of the portable memory device 120 has the second identity code ID2, that is, the host 110 has executed the security setup function 126 upon the portable memory device 120. In this case, the flow enters Step 206 to execute the security check function 128.

In Step 204, the host 110 executes the security setup function 126 to transmit the first identity code ID1 to the portable memory device 120, and sets the second identity code ID2 according to the first identity code ID1. At this time, the status of the identity code write-disable control code ICW is set to be “1”. In Step 206, the host 110 transmits the first identity code ID1 to the portable memory device 120, and the portable memory device 120 executes the security check function 128 to compare the first identity code ID1 and the second identity code ID2 to generate a comparison result. In Step 208, it is determined if the comparison result is correct, wherein if the comparison result is incorrect, a status of the data read/write_enable control code DRW is set to be “0”, that is, the host 110 is not allowed to access the portable memory device 120 (Step 210); and if the comparison result is correct, the status of the data read/write_enable control code DRW is set to be “1”, that is, the host 110 is allowed to access the data storage block 124 of the portable memory device 120 (Step 210).

It is noted that, in another embodiment of the present invention, the host 110 executes the security setup function 126 upon the portable memory device 120 only when the portable memory device 120 is first connected to the host 110. That is, the portable memory device 120 undergoes the security setup function 126 only by the host that the portable memory device 120 is first connected to. In addition, the portable memory device 120 is only allowed to undergo the security setup function 126 once, and the second identity code ID2 can only be set (generated) once.

In practice, the security setup function 126 of the host 110 and the security check function 128 of the portable memory device 120 are implemented by hardware (circuit). These two functions can also be implemented by software, however. In addition, the host 110 further includes hardware or software to check the status of the identity code write-disable control code ICW and transmit the first identity code ID1 to the portable memory device 120.

In practice, the host 110 can directly use the first identity code ID1 to set the second identity code ID2 (i.e., the second identity code ID2 is copied from the first identity code ID1). Therefore, when the comparison result indicates that the second identity code ID2 is the same as the first identity code ID1, the host 110 is allowed to access the portable memory device 120.

Briefly summarized, in the data access system of the present invention, when the portable memory device is first electrically connected to the host, the host executes the security setup function upon the portable memory device to ensure that the portable memory device can only be accessed by this host. In addition, when the portable memory device is electrically connected to any host a next time, the portable memory device will execute the security check function to determine if that particular host is allowed to access the storage device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data access system, comprising:
a host comprising a security setup function and a first identity code storage block, wherein the first identity code storage block comprises a first identity code;
a storage device comprising a security check function, wherein the storage device executes the security check function and determines whether the host is allowed to access the storage device according to at least the first identity code.

2. The data access system of claim 1, wherein the storage device further comprises a second identity code storage block, and the host executes the security setup function to set a second identity code according to the first identity code, the second identity code is stored into the second identity code storage block, and the storage device executes the security check function and determines whether the host is allowed to access the storage device according to the first identity code and the second identity code.

3. The data access system of claim 2, wherein the host executes the security setup function only when the storage device is electrically connected to the host and the second identity code storage block does not comprise the second identity code.

4. The data access system of claim 3, wherein the host executes the security setup function only when the storage device is first connected to the host.

5. The data access system of claim 2, wherein when the storage device is electrically connected to the host and the second identity code storage block comprises the second identity code, the storage device executes the security check function to compare the first identity code and the second identity code to generate a comparison result, and the storage device determines whether the host is allowed to access the storage device according to the comparison result.

6. The data access system of claim 5, wherein the host executes the security setup function to directly use the first identity code to set the second identity code, and when the comparison result indicates that the second identity code is the same as the first identity code, the storage device determines the host is allowed to access the storage device.

7. The data access system of claim 2, wherein the storage device can only undergo the security setup function once, and the second identity code can only be set once.

8. The data access system of claim 1, wherein the storage device is a portable storage device.

9. The data access system of claim 8, wherein the portable storage device is a portable memory device.
